(19) United States
(12) Patent Application Publication
(10) Pub. No.: US 2017/0086614 A1
(43) Pub. Date: Mar. 30, 2017

(54) MAGNETIC COASTER

(71) Applicant: NEW POTATO TECHNOLGIES, INC., Wilmington, NC (US)

(72) Inventors: STUART E. ROSS, WILMINGTON, NC (US); ANTON STARODUBTSEV, WILMINGTON, NC (US)

(73) Assignee: NEW POTATO TECHNOLOIGIES, INC., Wilmington, NC (US)

(21) Appl. No.: 15/277,644

(22) Filed: Sep. 27, 2016

Related U.S. Application Data
(63) Continuation-in-part of application No. 15/277,536, filed on Sep. 27, 2016.
(60) Provisional application No. 62/233,395, filed on Sep. 27, 2015.
(60) Provisional application No. 62/233,364, filed on Sep. 27, 2015.

(51) Int. Cl. A47G 23/03; F16B 1/00

(52) U.S. Cl. CPC A47G 23/03; F16B 1/00; A47G 2200/106; F16B 2001/0035; A47G 2200/103

(57) ABSTRACT

A coaster configured to engage another object, specifically a coaster or coaster-like device with means to attach to another object including an object with which is it meant to interact. In a preferred embodiment, the coaster contains a magnetic material capable of engaging with another magnetic component—a soft or hard magnet, an electromagnet or other magnetic material—located on or within another object. An additional magnet can be integrated into or attached to the coaster. The coaster can be imprinted with any number of designs, logos, or custom artwork making them an attractive vehicle for marketing efforts or imprinted with game boards or other graphics integral to user interaction with the host device.

### CROSS-REFERENCE TO RELATED APPLICATIONS

This Application claims the benefit of priority to U.S. Provisional Application No. 62/233,395 filed on Sep. 27, 2015. The content of U.S. Provisional Application No. 62/233,395 filed on Sep. 27, 2015 is incorporated by reference in its entirety. This Application also claims the benefit of priority to U.S. Provisional Application No. 62/233,364 filed on Sep. 27, 2015. The content of U.S. Provisional Application No. 62/233,364 filed on Sep. 27, 2015 is incorporated by reference in its entirety. This Application also claims the benefit of priority to U.S. Non-Provisional application Ser. No. 15/277,536 filed on Sep. 27, 2016. The content of U.S. Non-Provisional application Ser. No. 15/277,536 filed on Sep. 27, 2016 is incorporated by reference in its entirety.

### STATEMENT REGARDING FEDERALLY SPONSORED RESEARCH OR DEVELOPMENT

Not Applicable.

### THE NAMES OF THE PARTIES TO A JOINT RESEARCH AGREEMENT

Not Applicable.

### INCORPORATION-BY-REFERENCE OF MATERIAL SUBMITTED ON A COMPACT DISC

Not Applicable.

### BACKGROUND OF THE INVENTION

(a) Field of the Invention

The present invention is in the technical field of beverage coasters and similar items that a beverage may be placed upon to protect the surface of a bar or table beneath the item. More particularly, the present invention is in the technical field of beverage coasters that may couple to another base object such as the receiver component of a standard restaurant wait list paging system or the housing of beverage tampering alert and deterrent system.

(b) Background Art

Restaurant, bar and social drinking settings have given rise to varying notification systems that employ receiver or indicator components that are or may be coupled to a decorative or functional coaster. For instance, in lieu of maintaining a wait list using the traditional method of pen and paper, many restaurants now utilize a wait list paging system featuring a transmitter controlled by the restaurant hostess, and a receiver given to the waiting patron. The receiver component of these systems is typically a relatively flat component featuring a vibration and lighted alert system that engages when the transmitter signals the receiver. The tendency of these receiver components to be flat serves dual purposes in that the design (i) makes the receivers easily stacked when not in use, and (ii) allows a receiver in the possession of a patron to be utilized in place of a traditional coaster for protecting a bar or table surface from condensation from a beverage placed on top of the receiver.

A second type of notification system employing an indicator component that may be coupled to a decorative or functional coaster is the subject of U.S. Application No. 62/233,364 filed on Sep. 27, 2015. The 62/233,364 application discloses a system and method for deterring someone from attempting to introduce a substance into a user's drink and for alerting a user when such an attempt has taken place. The system includes a device consisting of a lid, housing, cover, or other suitable object that can fit over the mouth of a beverage container. In a preferred embodiment, the exterior of the device is a housing configured to accept the placement of a standard coaster on top of the device. The full background and concept of the 62/233,364 disclosure is described and identified in greater detail below.

The advent of various amnesia inducing drugs, commonly referred to as date rape drugs, has created a serious societal problem. More specifically, people use drugs such as Rohypnol and gamma hydroxybutyric (GHB) to poison the beverages of unsuspecting victims, even in public social settings. Typically, the offender will place such a drug in the drink of their victim when the victim is not paying attention to the drink or otherwise in control of their beverage container. This is such a common problem that young women are oftentimes counselled not to accept a drink in an open container from anyone other than a bartender.

This problem is not new so it is no surprise that other inventors have attempted to develop devices and systems to prevent someone from introducing a substance into another person's beverage. For example, Virginia M. Drogo filed an application on a beverage lid designed to prevent the introduction of substances into a user's drink that can be found in USPTO Publication Number US2013/0082067 (hereinafter the “Drogo Reference”). The Drogo reference discloses a drink lid made of plastic and/or elastic material that is meant to be a one-size-fits-all lid for beverages. The lid prevents the introduction of a substance into the beverage container simply by covering the opening of the mouth of the container. The Drogo reference also teaches the use of messages being printed on the portion of the lid that allow the user to put would be predators on notice that they are aware of the problem of date rape. The obvious drawback to this system is that it still requires the user to pay attention to whether or not someone removes or displaces the lid far enough to introduce a substance into the beverage. If the user or another person does not witness someone attempting to contaminate the beverage then the purpose of the device is defeated. In other words, a lid helps to prevent someone from introducing a substance into a beverage container, but it does not alert the user that such an act has transpired.

Another group of inventors developed and disclosed a method of detecting a date rape drug once the drug has already been introduced into the beverage (disclosed in PCT Application Number PCT/US2002/015088, hereinafter the “Glover et al. Reference”). The Glover et al. reference teaches the user to “test” the beverage by taking a sample of the beverage, placing it on the indicator and observing the indicator to see if the test results are positive. This method requires the user to wait until the sample has dried to detect the results of the test. In addition, if the user has left their beverage unattended or otherwise stopped paying attention to it, they would need to retest the beverage before consuming any more of it which makes the system rather cumbersome to use effectively. While this may be a practical way to test one's beverage if the user suspects the beverage has been contaminated, it does nothing to prevent the introduction of a substance into a beverage when the user is not paying attention to the beverage. In addition, it is likely there are drugs that this system cannot detect which could lead to a user to be misinformed as to whether their beverage was contaminated or not.

Yet another solution to the problem of date rape drugs being introduced into a user's beverage was presented by Go Simon Sunatoriin in Canadian Application Number CA2422687 (hereinafter the “Sunatoriin Reference”). The Sunatoriin Reference discloses a cylindrical collapsible tube-like structure that can enclose a beverage container with a lid that can be locked into place. While this system would probably make it quite difficult for someone to access the beverage, it will also make it difficult for the user to access the beverage. Moreover, should the user leave their beverage unattended, the system is only effective to the extent someone cannot find a way to unlock and remove the lid. The Sunatoriin reference does not teach a method of alerting a user when their beverage has been contaminated.

In the restaurant paging system, date rape drugging deterrent and alert system, and similar contexts, the importance of the now disclosed invention lies in the understanding that these aforementioned systems feature components that are far more complex and expensive to manufacture than a traditional coaster and, therefore, the idea that these system components would be or should be individually branded for the contexts in which they are utilized is simply not cost effective or practical. Accordingly, it would make sense to have a mechanism integrated within these system components whereby an inexpensive branded or decorative coaster may be interchangeably coupled with the coaster and, in the deterrent and alert system context, a mechanism integrated within the indicator component that retains the coaster flush with the component when the component is turned upside down.

The device disclosed in the present application relates to a coaster that is capable of being used with the above device or any other device configured to accept a coaster or coaster like object.

### BRIEF SUMMARY OF THE INVENTION

The present invention relates to a coaster capable of engaging with any device configured to accept or house a coaster including a warning system that alerts a user of an attempt to contaminant the user's beverage.

While any known means of attachment can be used to releasably affix a coaster or coaster-like object to another device including adhesives, hook and loop fastener systems, etc., the preferred embodiment consists of a coaster equipped with or containing a magnetic component that can interact with and engage a separate device, lid, base, housing, etc. In a preferred embodiment, the coaster is made of a porous paper based material that can be cheaply made. In a further preferred embodiment, the upper surface of the coaster can be adorned with any number of logos and designs to suit the particular establishment or user. In this embodiment, it is envisioned that the magnetic component with which the coaster is equipped is attached to the lower surface of the coaster with an adhesive device such as a sticker. The sticker can also be customized to sport a particular logo or design.

Ideally, the user places the coaster on top of a device, housing, or lid that is also placed over the mouth of a beverage container. Some such devices may have an upper surface featuring an annular lip that defines a recess into which a coaster rests. A separate, complementary magnetic component contained in the device acts to hold the coaster in place when it is seated in the recess of the device. As a result, when the lid or housing is turned upside down so as to be placed over the mouth of a beverage, the coaster device stays affixed.

### BRIEF DESCRIPTION OF THE SEVERAL VIEWS OF THE DRAWINGS

FIG. 1 is a plan view of the lower surface of the coaster;

FIG. 2 is a plan view of the upper surface of the coaster; and

FIG. 3 is a vertical cross section of the coaster and device with which it engages.

### DETAILED DESCRIPTION OF THE INVENTION

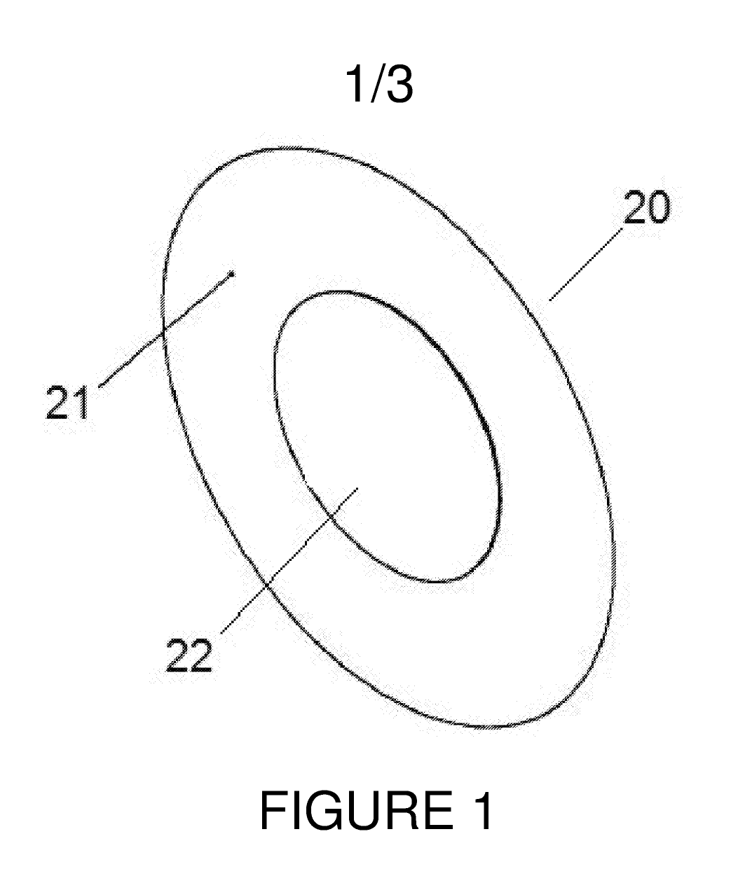

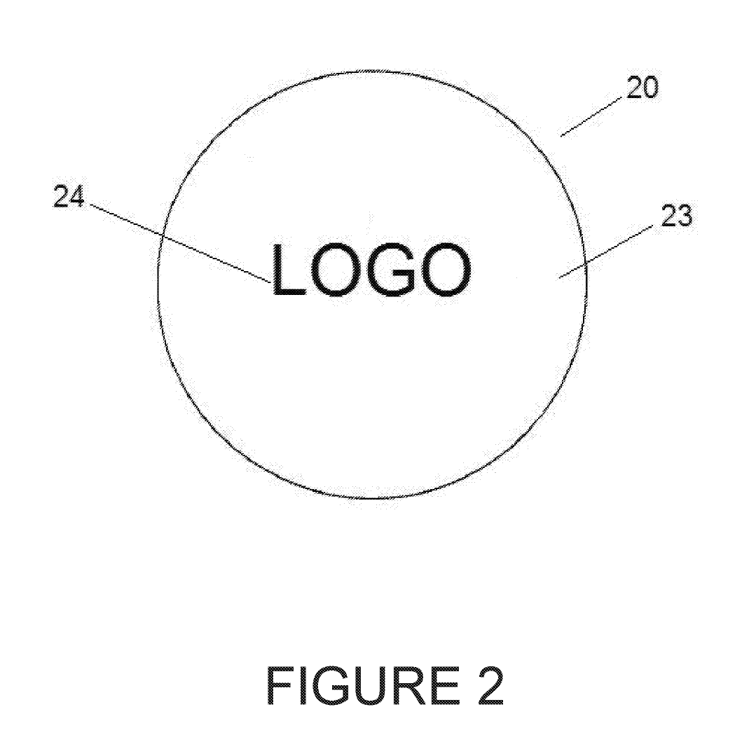

Referring now to the invention in more detail, in FIG. 1 there is shown the lower surface 21 or bottom of the coaster, generally 20. The coaster can take virtually any shape desired and will typically have an upper surface (see FIG. 2) and a lower surface 21. Affixed to the lower surface 21 of the coaster 20 is a magnetic component (not shown), for example, a magnet or magnetic material such as ferrous metal. Also affixed to the lower surface 21 of the coaster 20, is an adhesive device 22 such as a sticker that is used to attach the magnetic component (not shown) to the lower surface 21 of the coaster 20. In FIG. 2, there is shown the upper surface 23 of the coaster device 20. A graphic design, lettering or a logo 24 can be printed on the upper surface 23.

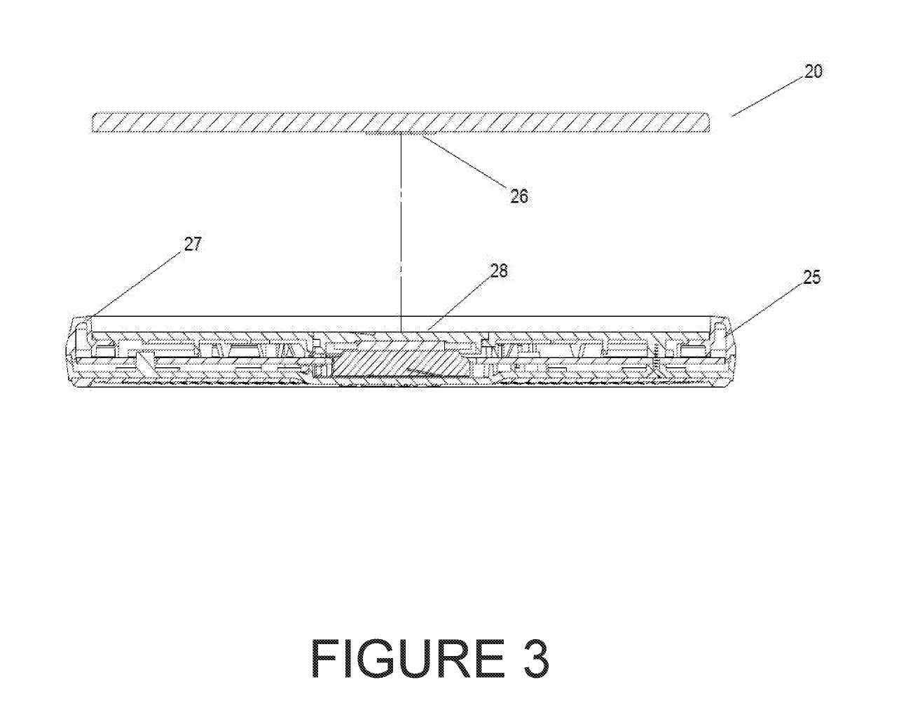

In more detail, referring to the invention of FIG. 3, the coaster 20 is shown in proximity to a device 25 such as the one described in U.S. Application No. 62/233,364. The device in that application is used for reference only as the coaster disclosed in this application is capable of being used with any device configured to accept or engage with a coaster. FIG. 3 also shows the magnetic component 26 uncovered by an adhesive device or sticker. The coaster 20 is configured to be seated on top of the lid or housing that makes up the device 25. In a preferred embodiment, annular lip 27 forms a recess 28 in which the coaster 20 is seated. The magnetic component 26 is affixed to one surface of the coaster 20 such that it is in position to engage with a magnetic component in the device 25. In a preferred embodiment and the best mode of the device, the magnetic component in the device 25 is a neodymium magnet, but it could also be a permanent magnet and/or an electromagnet. The magnet contained in the device 25 acts to hold the coaster 20 in place when it is seated in the recess 28 of the coaster 20. As a result, when the device 25 is turned upside down so as to be placed over the mouth of a beverage container, the coaster 20 stays affixed to the device 25 because the magnetic component 26 interacts with the magnet in the device 25.

An alternate embodiment of the coaster device uses an electromagnet in place of the magnet located in the device 25. Using the electromagnet, the user can attract or repel the coaster to or away from the device 25 allowing the user to either secure the coaster 20 to the device 25 or to “eject” the coaster 20 from the device 25. In addition, the inventors contemplate the coaster 20 may also contain a second magnet (not shown) that in addition to the magnetic component 26 so as to increase the attractive force between the coaster 20 and the housing or device 25.

The advantages of the present invention include, without limitation, the ability to use a standard coaster to engage with a separate device including or comprising a warning system that alerts a user to the possibility their drink has been contaminated with a foreign substance, such as a drug.

Reference throughout the specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout the specification may, but do not necessarily, refer to the same embodiment. Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

It is understood that the above described embodiments are only illustrative of the application of the principles of the present invention. The present invention may be embodied in other specific forms without departing from its spirit or essential characteristics. The described embodiment, including the best mode, is to be considered in all respects only as illustrative and not restrictive. The scope of the invention is, therefore, indicated by the appended claims, if any, in conjunction with the foregoing description.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

We claim:

1. A system for releasably affixing a coaster to a housing comprising:
a coaster with a piece of magnetic material affixed thereto and
a housing having a magnet affixed thereto.

2. The system of claim 1 wherein the magnet is a Neodymium magnet.

3. The system of claim 1 wherein the magnet is an electromagnet.

4. The system of claim 1 wherein the magnet is a permanent magnet.

5. The system of claim 1 wherein the magnetic material is a ferrous metal.

6. The system of claim 1 wherein the coaster has a second magnet integrated into a surface of the coaster.

7. The system of claim 2 wherein the coaster has a second magnet integrated into the coaster.

8. The system of claim 3 wherein the coaster has a second magnet integrated into the coaster.

9. The system of claim 4 wherein the coaster has a second magnet integrated into the coaster.

10. The system of claim 5 wherein the coaster has a second magnet integrated into the coaster.

11. A device for affixing a coaster to a platform or surface containing a magnet comprising:
a coaster and
a piece of magnetic material embedded in the coaster.

12. The system of claim 11 wherein the magnet is an electromagnet.

13. The system of claim 11 wherein the magnet is a permanent magnet.

14. The system of claim 11 wherein the coaster also has a magnet integrated into the coaster.

15. The system of claim 12 wherein the coaster has a second magnet integrated into the coaster.

16. The system of claim 13 wherein the coaster has a second magnet integrated into the coaster.

17. The system of claim 14 wherein the coaster has a second magnet integrated into the coaster.

18. The system of claim 15 wherein the coaster has a second magnet integrated into the coaster.

19. A method of retaining a coaster affixed to a surface when the surface is turned upside down comprising:
affixing a piece of magnetic material to the approximate center of the coaster,
affixing a magnet to the approximate center of the surface,
placing the magnetic material over the surface such that the magnetic material is in close proximity to the magnet.

20. The method of claim 19 wherein the coaster also has a magnet attached to its surface.
